(19) United States
(12) Patent Application Publication
(10) Pub. No.: US 2020/0184174 A1
(43) Pub. Date: Jun. 11, 2020

(54) ELECTRONIC DEVICE COMPRISING FINGERPRINT SENSOR

(71) Applicants: Samsung Electronics Co., Ltd., Gyeonggi-do (KR); Research & Business Foundation Sungkyunkwan University, Gyeonggi-do (KR)

(72) Inventors: Kyung-Hoon SONG, Gyeonggi-do (KR); Jung-Hoon CHUN, Gyeonggi-do (KR)

(21) Appl. No.: 16/627,006

(22) PCT Filed: Apr. 23, 2018
(86) PCT No.: PCT/KR2018/004679

§ 371 Date: Dec. 27, 2019

(30) Foreign Application Priority Data
Jul. 27, 2017 (KR) 10-2017-0095423

(51) Int. Cl. G06K 9/00; G06F 3/044; G06F 3/041

(52) U.S. Cl. CPC G06K 9/0002; G06F 3/0412; G06F 3/0446

(57) ABSTRACT

An electronic device, according to various embodiments of the present invention, may comprise: a pixel array consisting of an arrangement of pixels, each forming a capacitance corresponding to at least a portion of an object; a protective layer disposed on the pixel array; and guide walls formed and arranged within the protective layer, wherein the guide walls have a lower dielectric constant than other portions of the protective layer and may be arranged at an interval corresponding to at least the width of the width or length of each of the pixels. The electronic device as above may vary according to the embodiments.

### TECHNICAL FIELD

Various embodiments of the disclosure relate to an electronic device. For example, various embodiments of the disclosure relate to a sensor for detecting a user's biometric information and an electronic device including the same.

### BACKGROUND ART

Typically, an electronic device means a device that performs a specific function according to a program incorporated therein, such as an electronic scheduler, a portable multimedia reproducer, a mobile communication terminal, a tablet PC, an image/sound device, a desktop/laptop PC, or a vehicular navigation system, including a home appliance. The above-mentioned electronic devices may output, for example, information stored therein as sound or an image. As the integration degree of such electronic devices has increased and super-high speed and large-capacity wireless communication has become popular, various functions have recently been provided in a single mobile communication terminal. For example, various functions, such as an entertainment function (e.g., a game function), a multimedia function (e.g., a music/video reproducing function), a communication and security function for mobile banking, a schedule management function, and an e-wallet function, are integrated in a single electronic device, in addition to a communication function.

Recently, in addition to a privacy protection function stored in an electronic device, security functions necessary for executing mobile banking, mobile credit cards, electronic wallets, or the like are installed in an electronic device, for example, a portable electronic device such as a mobile communication terminal. Security functions installed in an electronic device may include, for example, user authentication based on a password or a lock pattern set by a user and user authentication executed via a security company. The authentication method based on a password may have a low level of security due to a high possibility of leakage of the password, and the authentication method executed via a security company may be troublesome due to the intervention of the security company. A biometric authentication method as an alternative to these methods, such as a user authentication method using fingerprint or iris recognition is able to enhance use convenience while securing a considerable level of security.

### DETAILED DESCRIPTION OF THE INVENTION

### Technical Problem

The user authentication method through fingerprint recognition includes a method using an optical structure, an ultrasonic method, or the like. This is a method of detecting a fingerprint image of a user from the light or ultrasound reflected from the user fingerprint by irradiating the user fingerprint with illumination or ultrasound. As another type, a capacitive fingerprint recognition sensor using a plurality of sensors and a pixel array composed of an array of electrodes or pixels may be proposed. In the capacitive fingerprint recognition sensor, the electrodes or pixels are capable of forming a capacitance with a subject (e.g., at least a portion of a user's fingerprint (e.g., ridge portions or valley portions)). Such capacitance may provide basic data for generating a user's fingerprint image. Such a capacitive fingerprint recognition sensor may have a simpler structure than a fingerprint recognition sensor (an optical structure or ultrasonic-type sensor) equipped with a light-emitting element or an ultrasonic oscillator.

In implementing the capacitive fingerprint recognition sensor, a passivation layer may be provided in order to provide a stable operating environment of the electrodes or pixels forming a capacitance. In forming such a protective layer, there may be a limitation in the thickness of the protective layer on the pixel array in order to ensure an appropriate distance (e.g., a recognition distance) at which the electrodes or pixels are capable of forming a capacitance.

In some embodiments, a fingerprint recognition sensor may detect a fingerprint image through contact with a user's body part (e.g., a finger). For example, the surface of the fingerprint recognition sensor (e.g., the surface of the protective layer) may be substantially exposed to the external environment, and may rub against an external object including a user's body part. Therefore, damage such as scratching may occur on the surface of the fingerprint recognition sensor, and the recognition rate of a fingerprint or the like may be reduced due to the damaged sensor surface.

Damage to the sensor surface may be prevented by placing a material of high hardness, such as a tempered glass film, on a protective layer, for example, on the sensor surface. However, processing a tempered glass film to be placed on the protective layer may be low in yield, even though the processing is costly and time consuming. Moreover, in view of the fact that the thickness of the protective layer is limited in order to secure an appropriate recognition distance, this processing cost or time may be further increased.

In some embodiments, an electrostatic fingerprint recognition sensor may be located in a display region (inside or above a display panel). When the fingerprint recognition sensor is located in the display region, the usability may be improved, but it is necessary to acquire the fingerprint image through several layers such as a display window, a polarization plate, a touch screen panel, and an adhesive layer, and such a layered structure may seriously degrade the quality of the fingerprint image by increasing the recognition distance.

Various embodiments of the disclosure may provide a capacitive finger print recognition sensor and an electronic device including the same.

Various embodiments of the disclosure may provide a capacitive finger print recognition sensor having a recognition distance increased in forming a capacitance with at least a portion of a subject and an electronic device including the same.

### Technical Solution

According to various embodiments of the disclosure, an electronic device may include:

a pixel array formed of an array of pixels, each of which forms a capacitance with at least a portion of a subject;

a protective layer disposed over the pixel array; and

guide walls formed and arranged in the protective layer.

The guide walls may have a lower dielectric constant than another portion of the protective layer and may be arranged at intervals corresponding to at least a width or a length of each of the pixels.

According to various embodiments of the disclosure, an electronic device may include:

a sensor layer including a first sensor and a second sensor configured to sense a capacitance with at least a portion of an external subject that is in contact with the electronic device, the sensor layer including a first region in which the first sensor is disposed, a second region in which a second sensor is disposed, and a third region disposed between the first region and the second region; and

a dielectric layer including a first partial region disposed over at least a partial region of the first region and the second region having a first dielectric coefficient and a second partial region disposed over the third region and having a second dielectric constant.

### Advantageous Effects

According to various embodiments of the disclosure, a fingerprint recognition sensor (and/or an electronic device including the same) includes guide walls formed in a protective layer disposed on a pixel array, whereby it is possible to suppress or alleviate the formation of a capacitance (e.g., a parasitic capacitance) corresponding to the peripheral portion of a region of interest (ROI) of each of the pixels. Through this, it is possible to acquire a fingerprint image in which the ridge portions and valley portions of a user's fingerprint are more clearly distinguished. In the fingerprint recognition sensor in which the guide walls are disposed as described above, it is possible to acquire a fingerprint image having a good resolution even when a subject is located at a distance when compared with a sensor in which the guide walls are not disposed. For example, the guide walls described above are capable of increasing the recognition distance of the fingerprint recognition sensor (e.g., the pixel array).

According to various embodiments of the disclosure, in manufacturing the capacitive fingerprint recognition sensor, since the recognition distance of the fingerprint recognition sensor is increased, it is possible to relax the thickness restriction of the protective layer (e.g., the tempered glass film having high hardness). For example, when processing a material having high hardness in manufacturing the protective layer, it is possible to reduce a processing cost and time, and even if the same processing cost or time is required, it is possible to at least improve at a yield.

### BRIEF DESCRIPTION OF DRAWINGS

FIG. 1 is a block diagram illustrating an electronic device within a network environment, according to various embodiments;

FIG. 2 is an exploded perspective view illustrating an electronic device including a fingerprint recognition sensor according to one of various embodiments of the disclosure;

FIG. 3 is a perspective view illustrating the electronic device including the fingerprint recognition sensor according to one of various embodiments of the disclosure;

FIG. 4 is a view illustrating the configuration of a fingerprint recognition sensor according to various embodiments of the disclosure;

FIG. 5 is a view illustrating an example of forming guide walls of a fingerprint recognition sensor according to various embodiments of the disclosure;

FIG. 6 is a plan view illustrating the state in which a fingerprint recognition sensor according to various embodiments of the disclosure is viewed through a protective layer from the outer surface of the protective layer;

FIG. 7 is a perspective view for explaining a molding layer of a fingerprint recognition sensor according to various embodiments of the disclosure;

FIG. 8 is a perspective view for explaining an adhesive layer of a fingerprint recognition sensor according to various embodiments of the disclosure;

FIG. 9 is a view illustrating the configuration of a fingerprint recognition sensor according to various embodiments of the disclosure for explaining the operation of the fingerprint recognition sensor;

FIG. 10 is a cross-sectional view illustrating an electronic device including a fingerprint recognition sensor according to one of various embodiments of the disclosure;

FIG. 11 is a graph showing results of an operation performance test of a fingerprint recognition sensor according to various embodiments of the disclosure.

FIGS. 12 and 13 are graphs showing capacitance values measured while changing the recognition distance of the fingerprint recognition sensor according to various embodiments of the disclosure in a comparative manner;

FIG. 14 is a graph showing gray values calculated on the basis of the results of an operation performance test of a conventional capacitive fingerprint recognition sensor; and

FIG. 15 is a graph showing gray values calculated on the basis of the results of an operation performance test of a fingerprint recognition sensor according to various embodiments of the disclosure.

### MODE FOR CARRYING OUT THE INVENTION

As the disclosure allows for various changes and numerous embodiments, some exemplary embodiments will be described in detail with reference to the accompanying drawings. However, it should be understood that the disclosure is not limited to the specific embodiments, but the disclosure includes all modifications, equivalents, and alternatives within the spirit and the scope of the disclosure.

Although ordinal terms such as “first” and “second” may be used to describe various elements, these elements are not limited by the terms. The terms are used merely for the purpose to distinguish an element from the other elements. For example, a first element could be termed a second element, and similarly, a second element could be also termed a first element without departing from the scope of the disclosure. As used herein, the term “and/or” includes any and all combinations of one or more associated items.

Further, the relative terms “a front surface”, “a rear surface”, “a top surface”, “a bottom surface”, and the like which are described with respect to the orientation in the drawings may be replaced by ordinal numbers such as first and second. In the ordinal numbers such as first and second, their order are determined in the mentioned order or arbitrarily and may not be arbitrarily changed if necessary.

In the disclosure, the terms are used to describe specific embodiments, and are not intended to limit the disclosure. As used herein, the singular forms are intended to include the plural forms as well, unless the context clearly indicates otherwise. In the description, it should be understood that the terms “include” or “have” indicate existence of a feature, a number, a step, an operation, a structural element, parts, or a combination thereof, and do not previously exclude the existences or probability of addition of one or more another features, numeral, steps, operations, structural elements, parts, or combinations thereof

Unless defined differently, all terms used herein, which include technical terminologies or scientific terminologies, have the same meaning as that understood by a person skilled in the art to which the disclosure belongs. Such terms as those defined in a generally used dictionary are to be interpreted to have the meanings equal to the contextual meanings in the relevant field of art, and are not to be interpreted to have ideal or excessively formal meanings unless clearly defined in the specification.

In the disclosure, an electronic device may be a random device, and the electronic device may be called a terminal, a portable terminal, a mobile terminal, a communication terminal, a portable communication terminal, a portable mobile terminal, a touch screen or the like.

For example, the electronic device may be a smartphone, a portable phone, a game player, a TV, a display unit, a heads-up display unit for a vehicle, a notebook computer, a laptop computer, a tablet Personal Computer (PC), a Personal Media Player (PMP), a Personal Digital Assistants (PDA), and the like. The electronic device may be implemented as a portable communication terminal which has a wireless communication function and a pocket size. Further, the electronic device may be a flexible device or a flexible display device.

The electronic device may communicate with an external electronic device, such as a server or the like, or perform an operation through an interworking with the external electronic device. For example, the electronic device may transmit an image photographed by a camera and/or position information detected by a sensor unit to the server through a network. The network may be a mobile or cellular communication network, a Local Area Network (LAN), a Wireless Local Area Network (WLAN), a Wide Area Network (WAN), the Internet, a Small Area Network (SAN) or the like, but is not limited thereto.

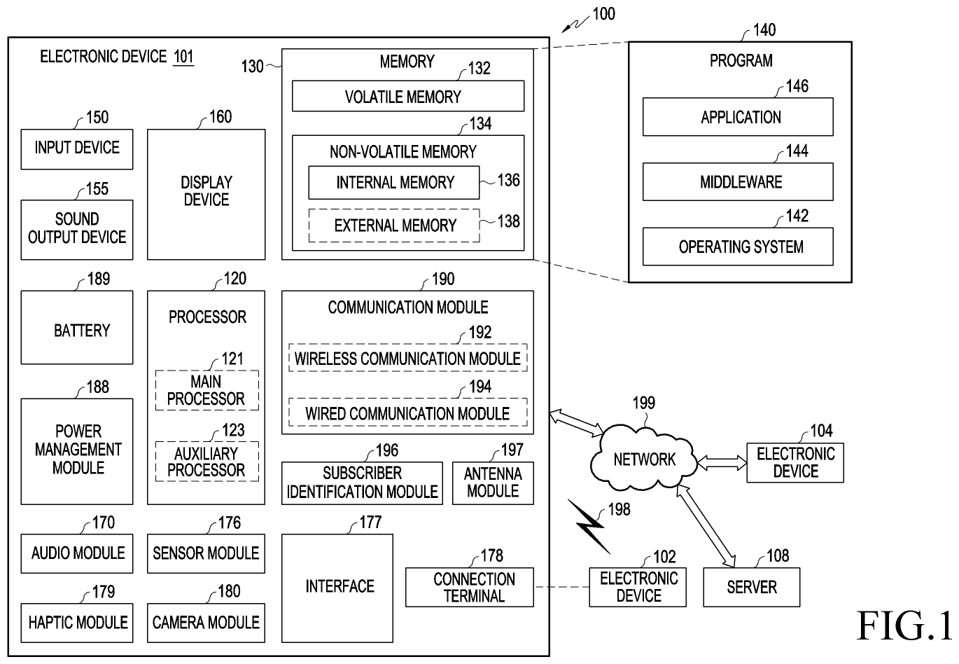

FIG. 1 is a block diagram illustrating an electronic device 101 in a network environment 100, according to various embodiments of the disclosure.

Referring to FIG. 1, in the network environment 100, the electronic device 101 may communicate with an electronic device 102 via a first network 198 (e.g., short-range wireless communication), or may communicate with an electronic device 104 or a server 108 via a second network 199 (e.g., long-range wireless communication). According to an embodiment, the electronic device 101 may communicate with the electronic device 104 via the server 108. According to an embodiment, the electronic device 101 may include a processor 120, a memory 130, an input device 150, a sound output device 155, a display device 160, an audio module 170, a sensor module 176, an interface 177, a haptic module 179, a camera module 180, a power management module 188, a battery 189, a communication module 190, a subscriber identification module 196, and an antenna module 197. In some embodiments, at least one (e.g., the display device 160 or the camera module 180) of these components may be eliminated from the electronic device 101 or other components may be added to the electronic device 101. In some embodiments, some components may be implemented in an integrated form as in the case of, for example, the sensor module 176 (e.g., a fingerprint recognition sensor, an iris sensor, or an illuminance sensor), which is embedded in, for example, the display device 160 (e.g., a display).

The processor 120 may control one or more other components (e.g., a hardware or software component) of the electronic device 101, which are connected to the processor 120, and may perform various kinds of data processing and arithmetic operations by driving, for example, software (e.g., a program 140). The processor 120 may load commands or data, which are received from other components (e.g., the sensor module 176 or the communication module 190), into a volatile memory 132 so as to process the commands or data, and may store the resultant data in a nonvolatile memory 134. According to an embodiment, the processor 120 may include a main processor 121 (e.g., a central processing unit or an application processor) and an auxiliary processor 123 operated independently from the main processor 121. The auxiliary processor 123 may additionally or alternatively use lower power than the main processor 121, or may include an auxiliary processor 123 specialized for a designated function (e.g., a graphic processor device, an image signal processor, a sensor hub processor, or a communication processor). Here, the auxiliary processor 123 may be operated separately from the main processor 121 or in the state of being embedded in the main processor 121.

In this case, the auxiliary processor 123 may control at least some functions or states associated with at least one of the components of the electronic device 101 (e.g., the display device 160, the sensor module 176, or the communication module 190), on behalf of the main processor 121, for example, while the main processor 121 is in an inactive (e.g., sleep) state, or together with the main processor 121 while the main processor 121 is in an active (e.g., application execution) state. According to an embodiment, the auxiliary processor 123 (e.g., an image signal processor or a communication processor) may be implemented a component of some of other functionally related components (e.g., camera module 180 or communication module 190). The memory 130 may store various data used by at least one component (e.g., the processor 120 or the sensor module 176) of electronic device 101, for example, software (e.g., the program 140) and input or output data, which is associated with a command associated the software. The memory 130 may include, for example, volatile memory 132 or nonvolatile memory 134.

The program 140 may be software stored in the memory 130 and may include, for example, an operating system 142, middleware 144, or application 146. [48] The input device 150 is a device for receiving, from the outside (e.g., user), a command or data to be used in a component (e.g., the processor 120) of the electronic device 101, and may include, for example, a microphone, a mouse, or a keyboard.

The sound output device 155 is a device for outputting a sound signal to the outside of the electronic device 101, and may include, for example, a speaker for general use such as multimedia reproduction or recorded sound reproduction and a receiver used only for telephone reception. According to an embodiment, the receiver may be formed integrally with or separately from the speaker.

The display device 160 is a device for visually providing information to a user of the electronic device 101 and may include, for example, a display, a hologram device, or a projector, and a control circuit configured to control the corresponding device. According to an embodiment, the display device 160 may include a touch circuit or a pressure sensor capable of measuring the intensity of a touch pressure.

The audio module 170 may bidirectionally convert sound and electrical signals. According to an embodiment, the audio module 170 may acquire sound through the input device 150 or may output sound through the sound output device 155 or an external electronic device (e.g., the electronic device 102 (e.g., a speaker or a headphone)) connected with the electronic device 101 in a wireless or wired manner.

The sensor module 176 may generate an electrical signal or a data value corresponding to an internal operating state (e.g., power or temperature) of the electronic device 101 or an external environmental condition. The sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support a designated protocol capable of being connected to an external electronic device (e.g., the electronic device 102) in a wired or wireless manner. According to an embodiment, the interface 177 may include a high definition multimedia interface (HDMI), a universal serial bus (USB) interface, an SD card interface, or an audio interface.

The connection terminal 178 may be a connector capable of physically interconnecting the electronic device 101 and an external electronic device (e.g., the electronic device 102), such as an HDMI connector, a USB connector, an SD card connector, or an audio connector (e.g., a headphone connector).

The haptic module 179 may convert an electrical signal into a mechanical stimulus (e.g., vibration or motion) or an electrical stimulus that may be perceived by the user through a tactile or kinesthetic sense. The haptic module 179 may include, for example, a motor, a piezoelectric element, or an electrical stimulation device.

The camera module 180 is capable of capturing a still image and a video image. According to an embodiment, the camera module 180 may include one or more lenses, an image sensor, an image signal processor, or a flash.

The power management module 188 is a module for managing power supplied to the electronic device 101, and may be configured as at least a part of, for example, a power management integrated circuit (PMIC).

The battery 189 is a device for supplying power to at least one component of the electronic device 101, and may include, for example, a non-rechargeable primary battery, a rechargeable secondary battery, or a fuel cell.

The communication module 190 may establish a wired or wireless communication channel between the electronic device 101 and an external electronic device (e.g., the electronic device 102, the electronic device 104, or the server 108) and may support communication via the established communication channel. The communication module 190 may include a processor 120 (e.g., an application processor) and one or more communication processors, which are independently operated and support wired communication or wireless communication. According to an embodiment, the communication module 190 may include a wireless communication module 192 (e.g., a cellular communication module, a short range wireless communication module, or a global navigation satellite system (GNSS) communication module) or a wired communication module 194 (e.g., a local area network (LAN) communication module or a power line communication module), and may communication with an external electronic device via a first network 198 (e.g., a short-range communication network, such as Bluetooth, Wi-Fi direct, or infrared data association (IrDA)) or a second network 199 (e.g., a long-range communication network, such as a cellular network, the Internet, or a computer network (e.g., LAN or WAN)), using a corresponding communication module among the above-mentioned communication modules. Various types of communication modules 190 described above may be implemented as a single chip in which at least some of the communication modules are integrated, or may be implemented as separate chips.

According to an embodiment, the wireless communication module 192 may identify and authenticate the electronic device 101 within the communication network using the user information stored in the subscriber identification module 196.

The antenna module 197 may include one or more antennas configured to transmit/receive signals or power to/from the outside. According to an embodiment, a communication module 190 (e.g., the wireless communication module 192) may transmit/receive signals to/from an external electronic device via an antenna suitable for the communication scheme thereof.

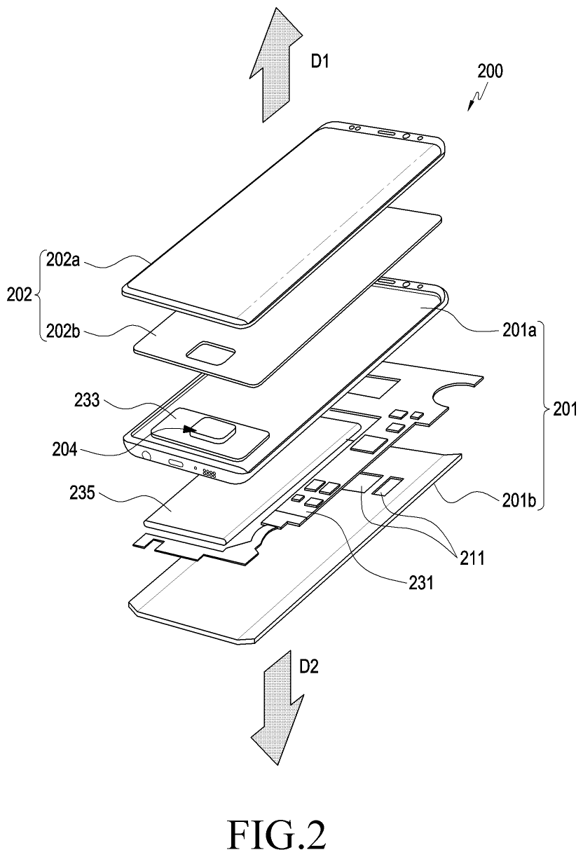

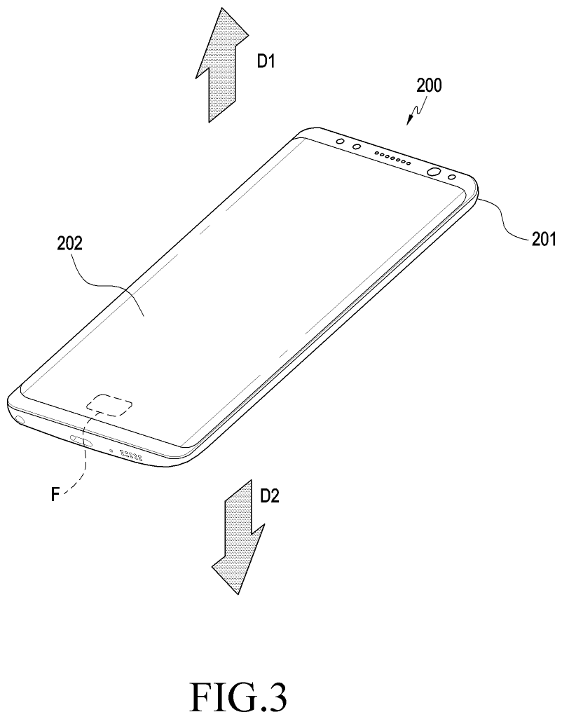

FIG. 2 is an exploded perspective view illustrating an electronic device 200 including a fingerprint recognition sensor 204 according to one of various embodiments of the disclosure. FIG. 3 is a perspective view illustrating the electronic device 200 including the fingerprint recognition sensor 204 according to one of various embodiments of the disclosure.

Referring to FIGS. 2 and 3, the electronic device 200 (e.g., the electronic device 101, 102, or 104 in FIG. 1) according to various embodiments of the disclosure may include a fingerprint recognition sensor 204, and the fingerprint recognition sensor 204 may be, for example, embedded in a display panel 202b or disposed in a structure stacked with the display panel 202b. In an embodiment, the fingerprint recognition sensor 204 may include pixels (or a pixel array consisting of an array of pixels) that form capacitance with at least a portion of a subject (e.g., a user's fingerprint). In another embodiment, the processor (e.g., the processor 120 in FIG. 1) of the electronic device 200 may generate a subject image (e.g., a fingerprint image) on the basis of the capacitance formed by each of the pixels.

According to various embodiments, the electronic device 200 may include a housing 201 and a display device 202 (e.g., the display device 160 in FIG. 1), and, for example, one or more circuit boards (e.g., a main circuit board 231 and/or an auxiliary circuit board 233) and a battery 235 (e.g., the battery 189 in FIG. 1) may be accommodated in the housing 201. In some embodiments, various modules and/or devices in FIG. 1 may be mounted on the main circuit board 231 or the like in the form of integrated circuit chips or electrical components.

The housing 201 may include a housing member 201a and a cover plate 201b, and may include a first surface (e.g., a front surface) oriented in a first direction D1, a second surface (e.g., a rear surface) oriented in a second direction D2 opposite to the first direction D1, and a side wall formed to at least partially surround a space between the first surface and the second surface. In an embodiment, the housing member 201a forms a space for accommodating the circuit boards (e.g., the main circuit board 231 and/or the auxiliary circuit board 233) or the like and the cover plate 201b may be coupled to the housing member 201a so as to form the second surface of the housing 201. In some embodiments, the first surface of the housing 201 may be at least partially open, and the display device 202 may be coupled to the first surface so as to close the first surface of the housing 201. For example, the exterior of the electronic device 200 may be substantially completed by coupling the display device 202 to the housing 201.

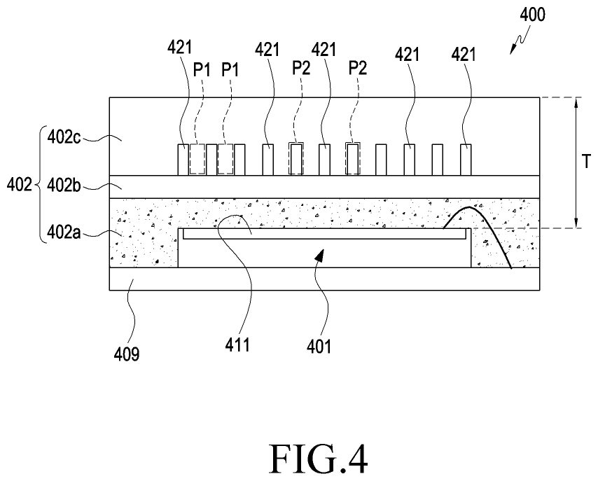

In an embodiment, the cover plate 201b may be molded and manufactured substantially integrally with the housing member 201a. For example, the housing 201 may be formed in a uni-body structure. In another embodiment, the cover plate 201b may include at least one opening 211. In the description of a specific embodiment of the disclosure, the term “opening” may mean, for example, a through hole formed to penetrate the cover plate 201b from the inner surface to the outer surface thereof and may also mean a transparent portion that optically/visually transmits light but does not connect the inner space and the outer space of the cover plate 201b. In an embodiment, the fingerprint recognition sensor 204 may be disposed on the cover plate 201b, for example, to correspond to the opening 211. More various examples of the configuration related to the arrangement of the fingerprint recognition sensor 204 will be described with reference to FIG. 4 or the like.

According to various embodiments, the display device 202 may include the display panel 202b and a window member 202a configured to protect the display panel 202b. The window member 202a may be mounted on the first surface of the housing 201 so as to provide a portion of the exterior of the electronic device 200. According to an embodiment, the pixel array of the fingerprint recognition sensor 204 (e.g., a pixel array 411 in FIG. 4) may be formed on a semiconductor device 401 or may be formed of an array of transparent electrodes using a conductor such as indium-tin oxide, and the pixel array may be embedded in the display panel 202b or may be stacked with the display panel 202b. The structure of the fingerprint recognition sensor 204, such as the pixel array, will be described in more detail with reference to FIG. 4.

FIG. 4 is a view illustrating the configuration of a fingerprint recognition sensor 400 according to various embodiments of the disclosure.

Referring to FIG. 4, the fingerprint recognition sensor 400 (e.g., the fingerprint recognition sensor 204 in FIG. 2) may include a pixel array 411, a protective layer (passivation layer) 402, and one or more guide walls 421.

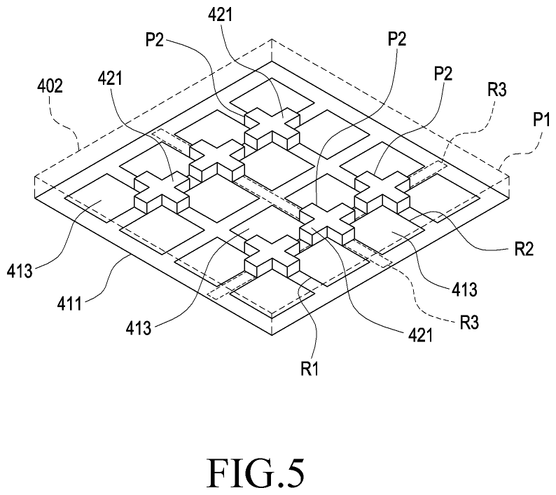

According to various embodiments, the pixel array 411 may include a sensor layer including an array of sensors (e.g., pixels 413 in FIG. 5), each of which forms a capacitance with at least a portion of a subject (e.g., a user's finger or fingerprint). A specific embodiment of the disclosure discloses an example in which a sensor layer (e.g., the pixel array 411) is formed in a semiconductor device 401 mounted on a circuit board 409. However, the disclosure is not necessarily limited thereto, and as described above, an electrode array formed of an array of transparent electrodes may replace the pixel array 411. When a capacitance corresponding to a subject is formed using an electrode array, the semiconductor device 401 may not be disposed.

In an embodiment, the semiconductor device 401 may be mounted on a circuit board (e.g., the auxiliary circuit board 233 in FIG. 2) of the above-described electronic device (e.g., the electronic device 200 in FIG. 2). The semiconductor device 401 may be connected to a circuit pattern of the circuit board 409 through wire bonding or the like so as to receive power or a control signal, or transmit data regarding a detected capacitance.

According to various embodiments, the protective layer 402 may include a dielectric layer that provides a stable operating environment of the pixel array 411 while preventing the pixel array 411 from being directly exposed to an external environment. For example, the protective layer 402 may block electromagnetic influences in forming a capacitance or may increase the sensitivity (e.g., the recognition distance) of the fingerprint recognition sensor 400 while protecting the pixel array 411 from an external environment.

According to an embodiment, the protective layer 402 may include a molding layer 402a (hereinafter, referred to as a “molding layer”). The molding layer 402a is formed to enclose the semiconductor device 401 on the circuit board 409 by applying, for example, epoxy or the like. In some embodiments, the molding layer 402a may provide a stable operating environment of, for example, the semiconductor device 401 (e.g., the pixel array 411). For example, the molding layer 402a may prevent the semiconductor device 401 or the like from being directly exposed to the external environment, thereby preventing contamination or damage caused by foreign matter, and may be made of a high dielectric constant material so as to improve the signal-to-noise ratio (SNR) and the like of the fingerprint recognition sensor 400, thereby increasing sensitivity (e.g., a recognition distance) in fingerprint recognition.

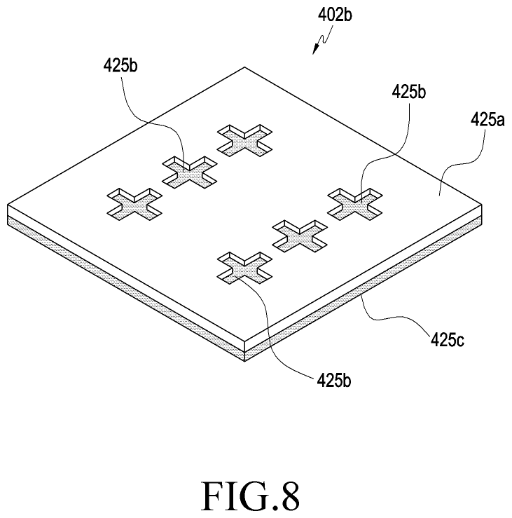

According to another embodiment, the protective layer 402 may include an adhesive layer 402b and/or a cover member 402c. The adhesive layer 402b may be formed on the surface of the molding layer 402a in order to bond the cover member 402c to the molding layer 402a. In some embodiments, the adhesive layer 402b may include an optical adhesive, a heat-curable adhesive, and a pressure-sensitive adhesive, and may be formed by applying such an adhesive to the surface of the molding layer 402a. Alternatively, the adhesive layer 402b may take a tape shape applied to at least one surface of a base film (e.g., the base film 425a in FIG. 8). The cover member 402c may be bonded to, for example, the molding layer 402a and may substantially form the surface of the fingerprint recognition sensor 400. For example, when detecting a user's fingerprint or the like, the user's finger may substantially come into contact with the surface of the cover member 402c. In some embodiments, the cover member 402c may be made of a material having a surface hardness of 9 H or more, such as tempered glass. In a specific embodiment of the disclosure, the tempered glass is represented as an example of the cover member 402c, but the disclosure is not limited thereto. For example, the fingerprint recognition sensor 400 according to various embodiments of the disclosure is capable of detecting a user's fingerprint or the like in a capacitive manner. Thus, the cover member 402c may be made of a material that has a predetermined dielectric constant (e.g., a dielectric constant of 7 or more) while providing a sufficient surface hardness so as to provide an environment in which the pixels of the pixel array 411 are capable of forming a capacitance with the user's body. For example, by forming the protective layer 402 described above using a material having a predetermined dielectric constant and thickness, it is possible to form an environment in which each of the pixels of the pixel array 411 is capable of forming capacitance with a user's body portion.

In some embodiments, the cover member 402c may be replaced with a window member (e.g., the window member 202a in FIG. 2) or a cover plate (e.g., the cover plate 201b in FIG. 2) of the electronic device. For example, when the fingerprint recognition sensor 400 is embedded in or stacked with the display panel 202b, a partial region of the window member 202a (e.g., a region indicated by “F” in FIG. 3) may be utilized as a cover member of the fingerprint recognition sensor 400 (e.g., the fingerprint recognition sensor 204 in FIG. 2). When the fingerprint recognition sensor 400 detects a user's fingerprint or the like on the second surface of the electronic device 200, a partial region of the cover plate 201b may be utilized as a cover member of the fingerprint recognition sensor 400. In another embodiment, the fingerprint recognition sensor 400 may be disposed on an opening (e.g., the opening 211 in FIG. 2) in the cover plate 201b. When the fingerprint recognition sensor 400 is disposed over the opening 211 of the cover plate 201b, the cover member 402c may be mounted on the electronic device 200 in the state of closing the opening 211. When a portion of the window member 202a or the cover plate 201b of the electronic device 200 is utilized as the cover member 402c, at least the portion utilized as the cover member 402c may have a predetermined dielectric constant (e.g., 7 or more) while providing a predetermined surface hardness (e.g., 9 H or more).

According to various embodiments, the dielectric layer (e.g., the protective layer 402) may include a first partial region P1 having a first dielectric constant and a second partial region P2 having a second dielectric constant different from the first dielectric constant. In the embodiment illustrated in FIG. 4, the first partial region P1 may be made of a glass material as a portion of the cover member 402c. For example, the first partial region P1 may be formed by a portion of the window member 202a of FIG. 2. According to an embodiment, the second partial region P2 may refer to a region in which the guide walls 421 are formed and may be formed of an epoxy-based resin.

According to various embodiments, the guide walls 421 may be arranged at predetermined intervals in the protective layer 402. For example, the guide walls 421 may include holes or recessed portions formed at predetermined intervals on the inner surface of the cover member 402c and may be arranged in a direction parallel to the pixel array 411. Each guide wall 421 may have a diaphragm shape for dividing a region illuminated by the pixel array 411 into regions corresponding to respective pixels or regions each corresponding to a plurality of adjacent pixels. For example, the guide walls 421 may be arranged to correspond to the width or length of each of the pixels or may be arranged at intervals greater than the width or length of each of the pixels.

FIG. 4 exemplifies that each of the guide walls 421 has a groove shape formed in the cover member 402c, but the disclosure is not limited thereto. For example, the guide walls 421 may also be formed on the adhesive layer 402b and/or the molding layer 402a and may be formed by a combination of grooves and the like formed in different layers in the protective layer 402. The formation positions of the guide walls 421 will be described in more detail with reference to FIGS. 5 to 8.

According to an embodiment, the guide walls 421 may have a dielectric constant different from that of the other portions of the protective layer 402. For example, the guide walls 421 may have a lower dielectric constant than the other portions of the protective layer 402. For example, the grooves formed in the inner surface of the cover member 402c may be each filled with air so as to have a lower dielectric constant than the molding layer 402a or the adhesive 402b forming another portion of the cover member 402c or a portion of the protective layer 402. In describing a specific embodiment of the disclosure, some numerical values are given as high or low examples regarding the dielectric constant of the protective layer 402 and the dielectric constant of the guide walls 421, but the disclosure is not limited thereto. For example, when the dielectric constant of the protective layer 402 is determined, the dielectric constant of the guide walls 421 may be set to be lower than that of the protective layer 402. For example, when the protective layer 402 includes a glass material having a dielectric constant of about 8, the guide walls 421 formed on the protective layer 402 may include an epoxy-based resin having a dielectric constant of about 3.5.

According to various embodiments, when the guide walls 421 have a low dielectric constant, the formation of a capacitance between the pixel array 411 (e.g., pixels) and a user's body (e.g., a fingerprint) on a path passing through the guide walls 421 may be suppressed. For example, the formation of capacitance corresponding to a region outside a region of interest (ROI) of each pixel constituting the pixel array 411 may be suppressed depending on the arrangement of the guide walls 421.

The fingerprint recognition sensor 400 described above may acquire a fingerprint image having a sufficient resolution required for detecting a user's fingerprint even at a distance of about 300 micrometers (μm) from the surface of the pixel array 411. In the same conditions in other structures/performance or the like, a fingerprint recognition sensor, which does not have the guide walls 421(s), may have difficulty in authenticating or identifying a user on the basis of a fingerprint image acquired at distances outside of approximately 250 micrometers (μm). For example, since the guide walls 421 suppress the formation of a parasitic capacitance when the fingerprint recognition sensor 400 generates a fingerprint image using a capacitive method, it is possible to improve the resolution of the fingerprint image or to increase the recognition distance. Therefore, in manufacturing the fingerprint recognition sensor 400, the thickness T of the protective layer 402 may be increased, which may enable the processing of the protective layer 402 (e.g., the cover member 402c) to be facilitated.

Hereinafter, various examples concerning the formation structure of the guide walls 421 will be described with reference to FIGS. 5 to 8.

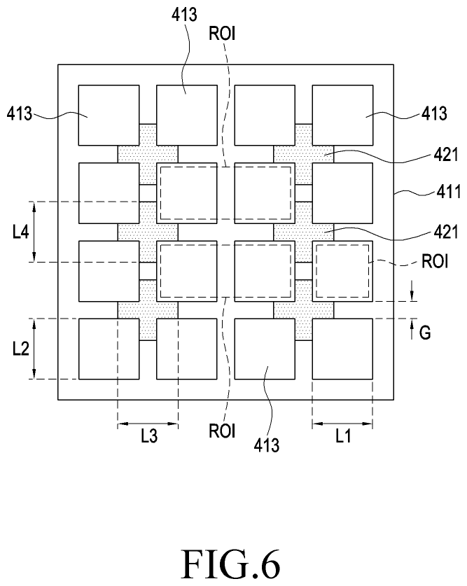

FIG. 5 is a view illustrating an example of forming guide walls 421 of a fingerprint recognition sensor according to various embodiments of the disclosure. FIG. 6 is a plan view illustrating the state in which a fingerprint recognition sensor according to various embodiments of the disclosure is viewed through a protective layer from the outer surface of the protective layer.

Referring to FIGS. 5 and 6, a sensor layer (e.g., the pixel array 411) may be formed of an array of a plurality of sensors (e.g., a plurality of pixels 413), and first or second regions R1 and R2 corresponding to respective pixels 413 and third regions R3 each formed between the first and second regions R1 and R2. According to an embodiment, first partial regions P1 having a first dielectric constant are substantially disposed over at least some of the first or second regions R1 and R2 and second partial regions P2 having a second dielectric constant may be disposed over the third regions R3. According to an embodiment, wires electrically connected to respective sensors (e.g., pixels 413) may be formed in the third regions R3.

According to various embodiments, the guide walls 421 may be formed in the second partial regions P2 corresponding to the third regions R3 in the dielectric layer (e.g., the protective layer 402) and may divide a region illuminated by the pixel array 411 (hereinafter, referred to as a “detection region”) into a plurality of regions. For example, the guide walls 421 may divide the detection region into regions illuminated by respective pixels 413 or may divide an area illuminated by at least two adjacent pixels 413 among the pixels 413 from other areas. Hereinafter, each region divided by the guide walls 421 will be referred to as a region of interest (hereinafter, “ROI”). For example, the guide walls 421 may set the ROI to correspond to each pixel 413 or to correspond to a plurality of adjacent pixels 413. In an embodiment, each of the pixels 413 may form a capacitance to corresponding to a subject in the ROI, for example, in a region surrounded by the guide walls 421 disposed therearound.

According to an embodiment, the guide walls 421 may be formed of a low dielectric constant material or grooves filled with a low dielectric constant material (e.g., air). For example, the guide walls 421 may suppress the formation of a capacitance between two objects (e.g., the pixels 413 and a partial region of a subject corresponding thereto). According to various embodiments, in the plan view of FIG. 6, each guide wall 421 may be disposed in a region of the pixel array 411 that does not overlap the pixels 413. For example, the guide walls 421 may be disposed between the pixels 413 in order to suppress the formation of a parasitic capacitance in a region outside of the ROI of each of the pixels 413 while facilitating the formation of a capacitance in the ROI of each of the pixels 413.

According to various embodiments, the pixels 413 may be manufactured to have a width L1 and a length L2, each of which is 50 micrometers, and may be disposed adjacent to other pixels with a 10 micrometer gap G therebetween. For example, each of the guide walls 421 may have a thickness corresponding to the gap G between the pixels 413, and may extend in the width L1 or length L2 direction of the pixels 413. The guide walls 421, each extending in the width L1 or length L2 direction of the pixels 413, may extend by a length L3 or L4 of about 30 micrometers. In the specific embodiment of the disclosure, the lengths L3 and L4 of the guide walls 421 are exemplified as being about 30 micrometers, but the disclosure is not necessarily limited thereto. For example, the guide walls 421 may extend to correspond to the entire width L1 or length L2 of the pixels 413 or to correspond to the entire length of the row or column in which the pixels 413 are arranged.

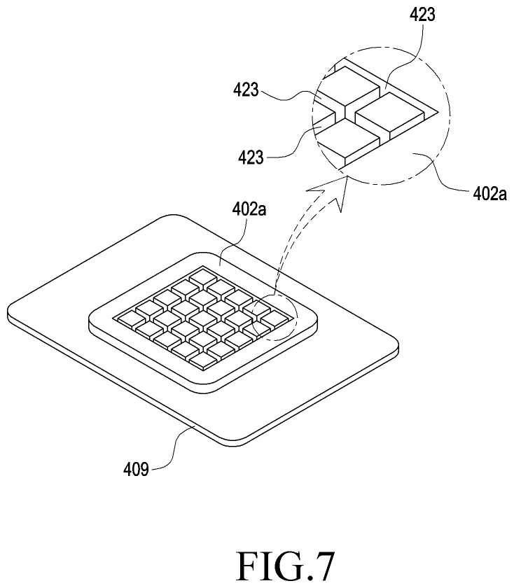

FIG. 7 is a perspective view for explaining a molding layer 402a of a fingerprint recognition sensor according to various embodiments of the disclosure.

Referring to FIG. 7, each of the guide walls 421 may include grooves 423 formed in the molding layer 402a. The grooves 423 may include, for example, slits formed in the surface of the molding layer 402a, and the slits may be filled with a low dielectric constant material (e.g., air). In an embodiment, the slits may be connected to each other to have a grid pattern. In some embodiments, when the guide walls are formed in the cover member 402c and/or the adhesive layer 402b, the slits may be extended/arranged along traces corresponding to the guide walls of the cover member 402c and/or the adhesive layer 402b.

FIG. 8 is a perspective view for explaining a molding layer 402b of a fingerprint recognition sensor according to various embodiments of the disclosure.

Referring to FIG. 8, the adhesive layer 402b may include a base film 425a, through holes 425b, and an adhesive 425c. For example, the adhesive layer 402b may have a tape shape including the adhesive 425c applied to at least one surface of the base film 425a. In some embodiments, the through holes 425b may be formed to penetrate the base film 425a, and may be filled with a low dielectric constant material (e.g., air) so as to provide the above-described functions of guide walls.

According to an embodiment, in the process of attaching the adhesive layer 402b to the molding layer 402a, a part of the adhesive 425c may fill the through holes 425b. In bonding the base film 245a or the cover member 402c to the surface of the molding layer 402a, the adhesive 425c may be evenly distributed throughout the bonding region. In some embodiments, the through-holes of the base film are filled with adhesive, and when the base film and the adhesive have different dielectric constants, a part of the base film may provide the above-described functions of guide walls. For example, since the adhesive is evenly distributed throughout the bonding area between the base film and the molding layer 402a (or between the base film and the cover member 402c), if the adhesive has a lower dielectric constant than the base film, the formation of capacitance may be impeded. According to an embodiment, when the through-holes of the base film are filled with the adhesive and the base film and the adhesive have different dielectric constants, the adhesive may have a higher dielectric constant than the base film, and the through-holes formed in the base film may be formed to correspond to the ROIs (e.g., the ROIs in FIG. 6). For example, the through-holes formed in the base film are filled with the adhesive while being formed corresponding to the ROIs, and at least a portion of the base film having a lower dielectric constant than the adhesive may provide the above-described functions of guide walls.

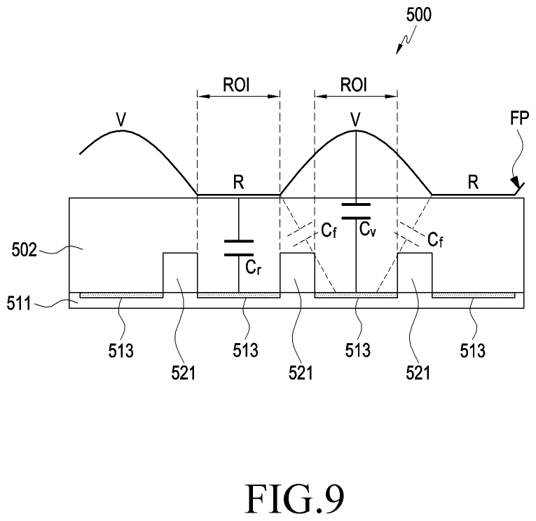

FIG. 9 is a view illustrating the configuration of a fingerprint recognition sensor 500 according to various embodiments of the disclosure for explaining the operation of the fingerprint recognition sensor 500.

Referring to FIG. 9, the fingerprint recognition sensor 500 (e.g., the fingerprint recognition sensor 204 or 400 in FIG. 2 or 4) may include a pixel array 511 (e.g., the pixel array 411 in FIG. 5) formed of an array of a plurality of pixels 513, a protective layer 502 disposed on the pixel array 511, and guide walls 521 formed in the protective layer 502. When the guide walls 521 are viewed through the protective layer 502 from the outer surface of the protective layer 502, each of the guide walls 521 may be disposed between at least two adjacent pixels 513, and each of the pixels 513 may form capacitances Cr and Cv with at least a portion of a subject in a region surrounded by the guide walls 521 disposed therearound. For example, as the subject (e.g., a user's body portion) comes into contact with the surface of the protective layer 502, the pixels 531 may form capacitances Cr and Cv corresponding to the subject in the ROI. In FIG. 9, “FP” may indicate a user's fingerprint curvature, “R” may indicate a ridge portion of the user's fingerprint, and “V” may indicate a valley portion of the user's fingerprint.

As described above, each of the guide walls 521 may be filled with a material having a lower dielectric constant than other portions of the protective layer 502 or may be formed of a low dielectric constant material. The capacitance formed between two objects or electrodes (e.g., the pixel(s) 513 and the corresponding portion of a subject) may be inversely proportional to the distance between the two objects, and may be proportional to the dielectric constant of the material(s) between the two objects. Each of the guide walls 521 has a low dielectric constant (e.g., a dielectric constant of 2 or less) and is disposed between the pixels 513, so that it is possible to suppress the formation of a parasitic capacitance Cf corresponding to a subject portion in a region outside the ROI. For example, by disposing the guide walls 521, the difference between the capacitances Cr and Cv, which are formed to correspond to the ridge portion R and the valley portion V of the fingerprint curvature FP, respectively, may be defined more clearly. Since the difference between the capacitances Cr and Cv, which are formed to correspond to the ridge R and the valley V, respectively, is defined more clearly, the resolution of the fingerprint image acquired through the fingerprint recognition sensor 500 is capable of being increased. A processor (e.g., the processor 120 in FIG. 1 or an image signal processor included therein) of an electronic device (e.g., the electronic device 101, 102, 104, or 200 in FIG. 1 or FIG. 2) may acquire a fingerprint image of a user on the basis of the difference between the capacitances Cr and Cv described above.

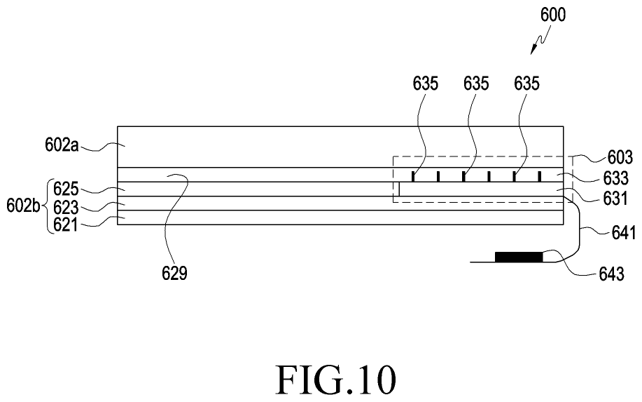

FIG. 10 is a cross-sectional view illustrating the configuration of an electronic device 600 including a fingerprint recognition sensor 603 according to one of various embodiments of the disclosure.

In the embodiment described with reference to, for example, FIG. 2, the fingerprint recognition sensor 204 is exemplified as a component separate from the display device 202 (e.g., the display panel 202b). However, as described above, the fingerprint recognition sensor according to various embodiments of the disclosure may be embedded in or stacked with the display device or the display panel.

Referring to FIG. 10, the electronic device 600 may include a window member 602a, a display panel 602b, and a fingerprint recognition sensor 603 embedded in or stacked with the display device or the display panel 602b. According to an embodiment, the display panel 602b may include a light-emitting layer 621, a polarization plate 623, and a touch screen panel 625. The light-emitting layer 621 may be enclosed between boards (not illustrated) bonded to face each other. In some embodiments, the touch screen panel 623 may be integrated into the window member 602a. The display panel 602b may be attached to the inner surface of the window member 602a via an adhesive layer 629 such as a pressure-sensitive adhesive or an optically clear adhesive.

According to various embodiments, the fingerprint recognition sensor 603 may include a pixel array 631 arranged on the polarization plate 623 and/or on the same layer as the touch screen panel 625 and a protective layer 633. The protective layer 633 may be formed to include a portion of the adhesive layer 629 and/or a portion of the window member 602a. For example, in the protective layer 402 of FIG. 4, the adhesive layer 402b may be formed by a portion of the adhesive layer 629. In an embodiment, in the protective layer 402 of FIG. 4, the cover member 402c may be formed by a portion of the window member 602a. In some embodiments, in the protective layer 402 of FIG. 4, the molding layer 402a may be formed on the same layer as the touch screen panel 625 together with the pixel array 631. In another embodiment, the molding layer 402a may be formed by another portion of the adhesive layer 629. For example, if the pixel array 631 is formed on the same layer as any one layer forming the display panel 602b, such as the touch screen panel 625, the molding layer 402a may be removed or deleted.

According to an embodiment, the fingerprint recognition sensor 603 may include one or more guide walls 635 (e.g., the guide walls 421 in FIG. 4) having a dielectric constant different from that of the protective layer 633. For example, the guide walls 635 may be disposed between the pixel array 631 and a subject (e.g., a user's fingerprint) and may suppress the formation of a capacitance corresponding to a region outside the region of interest of each pixel constituting the pixel array 631. The number and arrangement intervals of the guide walls 635 may be set in various ways in consideration of a usage environment of the fingerprint recognition sensor 603 or the like.

According to various embodiments, the electronic device 600 may include a flexible printed circuit board 641 extending from the display panel 602b and/or the fingerprint recognition sensor 603. For example, the display panel 602b and/or the fingerprint recognition sensor 603 may be connected to a main circuit board (e.g., the main circuit board 231 in FIG. 2) via the flexible printed circuit board 641 or may be provided with a driving signal via an integrated circuit chip 643 or the like provided on the flexible printed circuit board 641.

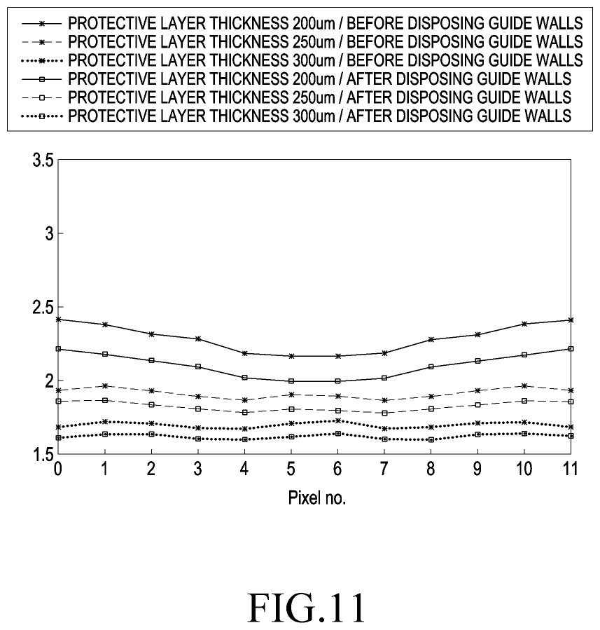

FIG. 11 is a graph showing results of an operation performance test of a fingerprint recognition sensor according to various embodiments of the disclosure.

The graph represented in FIG. 11 shows capacitances formed in respective pixels, in which the capacitances were measured before and after the formation of the guide walls described above while changing the recognition distance (e.g., the thickness T of the protective layer in FIG. 4) in the case in which the spacing of the ridges (e.g., the ridges R in FIG. 9) of a user's fingerprint (or the spacing of the valleys (e.g., the valleys V in FIG. 9) was about 200 micrometers. Pixel numbers represented on the horizontal axis in the graph of FIG. 11 are numbers sequentially assigned to pixels constituting one row or column selected from a pixel array (e.g., the pixel array 411 in FIG. 5). Pixel numbers 0 to 2 and 9 to 11 indicate pixels corresponding to the ridge portions R of the user's fingerprint, and pixel numbers 3 to 8 indicate pixels corresponding to the valley portions V of the user's fingerprint. However, this exemplifies a corresponding relationship between the pixels and the ridge portions or the valley portions at the time of this measurement, and the pixels corresponding to the ridge portions or the valley portions may vary depending on the measurement time.

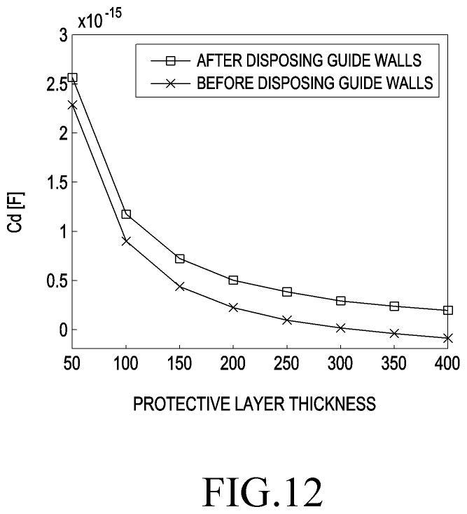

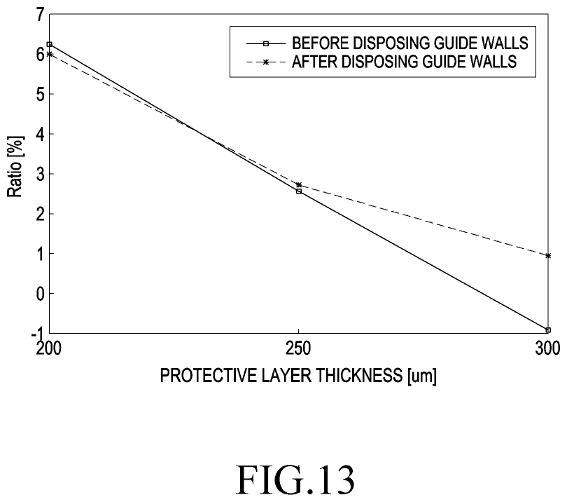

The measurement results of capacitances before and after the formation of the guide walls are represented in FIGS. 12 and 13 in a comparative manner.

FIGS. 12 and 13 are graphs showing capacitance values measured while changing the recognition distance of the fingerprint recognition sensor according to various embodiments of the disclosure in a comparative manner.

In FIG. 12, “Cd” is the difference between a measured value of capacitance Cr corresponding to ridge portions R and a measured value of capacitance Cv corresponding to valley portions V (hereinafter, referred to as a “difference value Cd”). It can be seen that when the measurement distance is changed in the measurement range of 100 to 400 micrometers, the difference value Cd in the fingerprint recognition sensor including the guide walls 521 is improved by about 0.3 to 0.4 fF compared with that in a fingerprint recognition sensor not including the guide walls.

Only with the fact that the difference value Cd has a positive value, it is possible to acquire a fingerprint image having a resolution that enables user authentication or identification according to a signal processing algorithm of a processor (e.g., the processor 120 of FIG. 1). Since the fingerprint recognition sensor (e.g., the fingerprint recognition sensor 500 of FIG. 9) according to various embodiments of the disclosure includes the guide walls, the capacitance difference value Cd may be further improved by including the guide walls. For example, the fingerprint recognition sensor according to various embodiments may reduce load caused due to signal processing for acquiring a fingerprint image by including the guide walls.

Meanwhile, in FIG. 12, it can be seen that when the measurement distance, for example, the thickness T of the protective layer 402 or 502 in FIG. 4 or FIG. 9 reaches about 300 micrometers, the difference value Cd in a conventional fingerprint recognition sensor (e.g., a fingerprint recognition sensor in which the above-described guide walls are not disposed) reaches substantially “0”. For example, when the measurement distance exceeds about 300 micrometers, the capacitance corresponding to the ridge portions and the capacitance corresponding to the valley portions measured by a conventional fingerprint recognition sensor become substantially the same, which may mean that it is impossible to distinguish the ridge portions and the valley portions. In contrast, the fingerprint recognition sensor according to various embodiments of the disclosure is capable of having a positive difference value Cd even when the measurement distance exceeds 300 micrometers, and thus it is possible to acquire a fingerprint image having a resolution required for user authentication (or identification).

In FIG. 13, “ratio” represents the ratio of the difference value Cd to the capacitance formed with the ridge portions R (hereinafter, referred to as “ratio”), and this ratio may have a tendency to gradually decrease as the measurement distance increases. Meanwhile, in FIG. 13, it can be seen that when the measurement distance reaches about 300 micrometers, the ratio in a conventional fingerprint recognition sensor (e.g., a fingerprint recognition sensor in which the above-described guide walls are not disposed) has a substantially negative value. For example, the measurement value of the capacitance formed with the ridge portions may be lower than the measurement value of the capacitance formed with the valley line portion. This is considered to be for the following reason: in a conventional fingerprint recognition sensor, as the measurement distance increases, the ratio of the measurement value of parasitic capacitance (e.g., the parasitic capacitance Cf in FIG. 9) to the measurement value of capacitance formed with the ridge portions or valley portions is significantly increased. In contrast, the fingerprint recognition sensor (e.g., the fingerprint recognition sensor 500 in FIG. 9) according to various embodiments of the disclosure is capable of maintaining a ratio of about 1% even when the measurement distance reaches 300 micrometers, and thus it is possible to acquire a fingerprint image having a resolution required for user authentication (or identification).

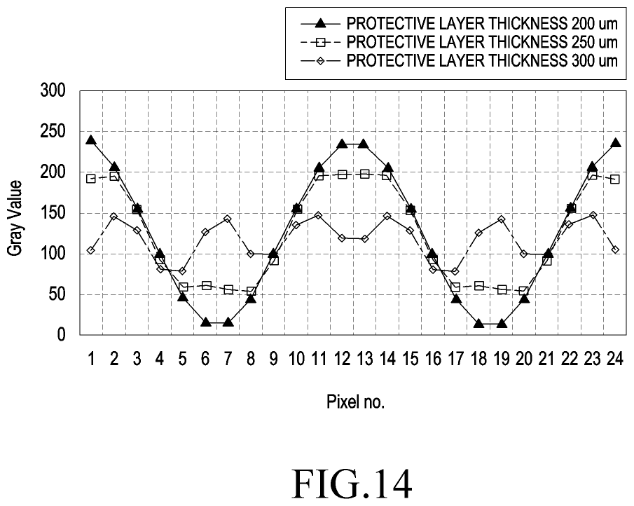

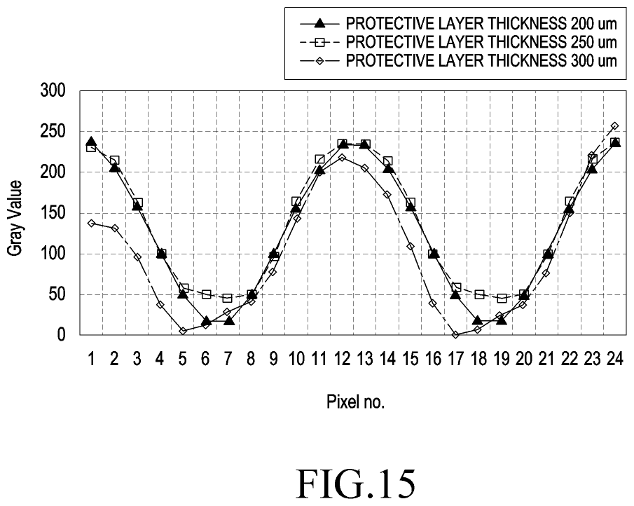

FIG. 14 is a graph showing gray values calculated on the basis of the results of an operation performance test of a conventional capacitive fingerprint recognition sensor. FIG. 15 is a graph showing gray values calculated on the basis of the results of an operation performance test of a fingerprint recognition sensor according to various embodiments of the disclosure.

FIGS. 14 and 15 are graphs obtained by calculating gray values of fingerprint images after acquiring the fingerprint images on the basis of capacitances formed by the respective pixels of fingerprint recognition sensors, and the measurement results may be compared according to the measurement distance, for example, the protective layer of FIG. 4. Referring to FIG. 14, in the conventional capacitive fingerprint recognition sensor, it is estimated that a fingerprint image having a good resolution may be obtained at a measurement distance in the range of 200 to 250 micrometers. However, at a measurement distance of 300 micrometers, it may be substantially difficult to distinguish the ridge portions and the valley portions. Referring to FIG. 15, it can be seen that the fingerprint recognition sensor according to various embodiments of the disclosure is capable of acquiring a fingerprint image having a good resolution even at a measurement distance of 300 micrometers while operating in a capacitive manner.

As described above, since the fingerprint recognition sensor according to various embodiments of the disclosure is capable of increasing the recognition distance, it is possible to acquire a good fingerprint image even if the thickness of the protective layer is further secured. For example, assuming that the cover member 402c of FIG. 4 is made of tempered glass, it is possible to provide an environment in which the tempered glass is capable of being processed to have a larger thickness. For example, in the case in which all other conditions are the same, assuming that the cover member of a conventional fingerprint recognition sensor is made of tempered glass having a thickness of 150 micrometers, the cover member of the fingerprint recognition sensor according to various embodiments of the disclosure may be made of tempered glass having a thickness of 200 micrometers or more. Accordingly, the fingerprint recognition sensor according to various embodiments of the disclosure is capable of reducing manufacturing costs or time (e.g., costs or time required for processing the cover member).

As described above, according to various embodiments of the disclosure, an electronic device may include:

a pixel array formed of an array of pixels, each of which forms a capacitance with at least a portion of a subject;

a protective layer disposed over the pixel array; and

guide walls formed and arranged in the protective layer.

The guide walls may have a lower dielectric constant than another portion of the protective layer and may be arranged at intervals corresponding to at least a width or a length of each of the pixels.

According to various embodiments, each of the pixels may form a capacitance with the subject in a region, which is surrounded by the guide walls disposed therearound, when viewed through the protective layer from an outer surface of the protective layer.

According to various embodiments, each of the guide walls may be disposed between at least two adjacent pixels when viewed through the protective layer from an outer surface of the protective layer.

According to various embodiments, the above-described electronic device may further include a semiconductor device mounted on the circuit board and including the pixel array, and

the protective layer may include a molding layer formed to enclose the semiconductor device on the circuit board.

According to various embodiments, each of the guide walls may include a hole or recessed portion formed on a surface of the molding layer, and

the hole or recessed portion may be filled with a low dielectric constant material.

According to various embodiments, the above-described electronic device may further include a semiconductor device mounted on the circuit board and including the pixel array, and

the protective layer may include a cover member mounted on the semiconductor device, and

each of the guide walls may include a hole or recessed portion formed in the inner surface of the cover member and filled with a low dielectric material.

According to various embodiments, the electronic device described above may further include a semiconductor device mounted on a circuit board and including the pixel array, and

the protective layer may include:

a molding layer formed to enclose the semiconductor device on the circuit board;

an adhesive layer formed on a surface of the molding layer; and

a cover member bonded to the molding layer by the adhesive layer.

According to various embodiments, the guide walls may be formed on at least one of the molding layer, the adhesive layer, and the cover member.

According to various embodiments, the adhesive layer may include:

a base film having a shape corresponding to the surface of the molding layer;

a plurality of through holes formed in the base film; and

an adhesive applied to at least one surface of the base film, and

the through boles or a portion of the base film between the through holes may form the guide walls.

An electronic device according to various embodiments of the disclosure may include:

a sensor layer including a first sensor and a second sensor configured to sense a capacitance with at least a portion of an external subject that is in contact with the electronic device, the sensor layer including a first region in which the first sensor is disposed, a second region in which a second sensor is disposed, and a third region disposed between the first region and the second region; and

a dielectric layer including a first partial region disposed over at least a partial region of the first region and the second region and having a first dielectric coefficient and a second partial region disposed over the third region and having a second dielectric constant.

According to various embodiments, the second partial region may have a lower dielectric constant than another portion of the dielectric layer and may be arranged at intervals corresponding to at least a width or a length of each of the pixels.

According to various embodiments, the second partial region may be disposed between the first sensor and the second sensor when viewed through the dielectric layer from the outer surface of the dielectric layer.

According to various embodiments, the electronic device described above may further include:

a housing including a first surface oriented in a first direction, a second surface oriented in a second direction opposite to the first direction, and a side wall formed to at least partially surround a space between the first surface and the second surface; and

a display device mounted on the first surface, and

the sensor layer may be disposed inside the display device.

According to various embodiments, the display device may include:

a display panel; and

a window member configured to transmit a screen output from the display panel, and

the dielectric layer may be formed to include a portion of the window member.

According to various embodiments, the electronic device described above may further include:

a housing including a first surface oriented in a first direction, a second surface oriented in a second direction opposite to the first direction, and a side wall formed to at least partially surround a space between the first surface and the second surface; and

an opening formed in the second surface of the housing, and

the sensor layer may be disposed over the opening.

According to various embodiments, the electronic device described above may further include:

a circuit board; and

a semiconductor device mounted on the circuit board.

The sensor layer may be formed by at least a part of the semiconductor device, and

the dielectric layer may further include:

a molding layer formed to enclose the semiconductor device on the circuit board;

an adhesive layer formed on a surface of the molding layer; and

a cover member bonded to the molding layer by the adhesive layer.

According to various embodiments, the electronic device described above may further include:

a housing including a first surface oriented in a first direction, a second surface oriented in a second direction opposite to the first direction, and a side wall formed to at least partially surround a space between the first surface and the second surface; and

an opening formed in the second surface of the housing, and

the cover member may be mounted to close the opening, and the sensor layer may be mounted in the housing.

According to various embodiments, the guide walls may be formed on at least one of the molding layer, the adhesive layer, and the cover member.

According to various embodiments, the adhesive layer may include:

a base film having a shape corresponding to the surface of the molding layer;

a plurality of through holes formed in the base film; and

an adhesive applied to at least one surface of the base film, and

the through boles or a portion of the base film between the through holes may form the guide walls.

According to various embodiments, the electronic device may further include a processor, and

the processor may generate an image of an external subject, which is in contact with the electronic device, on the basis of the capacitance formed by the first sensors or the second sensors.

While the disclosure has been shown and described with reference to certain embodiments thereof, it will be understood by those skilled in the art that various changes in form and details may be made therein without departing from the spirit and scope of the disclosure as defined by the appended claims. what is claimed is:

1. An electronic device comprising:
a pixel array formed of an array of pixels, each of which forms a capacitance with at least a portion of a subject;
a protective layer disposed over the pixel array; and
guide walls formed and arranged in the protective layer,
wherein the guide walls have a lower dielectric constant than another portion of the protective layer and are arranged at intervals corresponding to at least a width or a length of each of the pixels.

2. The electronic device of claim 1, wherein each of the pixels forms a capacitance with the subject in a region, which is surrounded by the guide walls disposed therearound, when viewed through the protective layer from an outer surface of the protective layer.

3. The electronic device of claim 1, wherein each of the guide walls is disposed between at least two adjacent pixels when viewed through the protective layer from an outer surface of the protective layer.

4. The electronic device of claim 1, further comprising:
a semiconductor device mounted on a circuit board and including the pixel array,
wherein the protective layer includes a molding layer formed to enclose the semiconductor device on the circuit board.

5. The electronic device of claim 4, wherein each of the guide walls includes a hole or recessed portion formed on a surface of the molding layer, and
the hole or recessed portion is filled with a low dielectric constant material.

6. The electronic device of claim 1, further comprising:
a semiconductor device mounted on a circuit board and including the pixel array,
wherein the protective layer includes a cover member mounted on the semiconductor device, and
each of the guide walls includes a hole or recessed portion formed in an inner surface of the cover member and filled with a low dielectric material.

7. The electronic device of claim 1, further comprising:
a semiconductor device mounted on a circuit board and including the pixel array,
wherein the protective layer includes:
a molding layer formed to enclose the semiconductor device on the circuit board;
an adhesive layer formed on a surface of the molding layer; and
a cover member bonded to the molding layer by the adhesive layer.

8. An electronic device comprising:
a sensor layer including a first sensor and a second sensor configured to sense a capacitance with at least a portion of an external subject that is in contact with the electronic device, the sensor layer including a first region in which the first sensor is disposed, a second region in which a second sensor is disposed, and a third region disposed between the first region and the second region; and
a dielectric layer including a first partial region disposed over at least a partial region of the first region and the second region and having a first dielectric coefficient and a second partial region disposed over the third region and having a second dielectric constant.

9. The electronic device of claim 8, further comprising:
a housing including a first surface oriented in a first direction, a second surface oriented in a second direction opposite to the first direction, and a side wall formed to at least partially surround a space between the first surface and the second surface; and
a display device mounted on the first surface,
wherein the sensor layer is disposed inside the display device.

10. The electronic device of claim 9, wherein the display device includes:
a display panel; and
a window member configured to transmit a screen output from the display panel,
wherein the dielectric layer is formed to include a portion of the window member.

11. The electronic device of claim 8, further comprising:
a housing including a first surface oriented in a first direction, a second surface oriented in a second direction opposite to the first direction, and a side wall formed to at least partially surround a space between the first surface and the second surface; and
an opening formed in the second surface of the housing,
wherein the sensor layer is disposed over the opening.

12. The electronic device of claim 8, further comprising:
a circuit board; and
a semiconductor device mounted on the circuit board.
wherein the sensor layer is formed by at least a part of the semiconductor device, and
the dielectric layer includes:
a molding layer formed to enclose the semiconductor device on the circuit board;
an adhesive layer formed on a surface of the molding layer; and
a cover member bonded to the molding layer by the adhesive layer.

13. The electronic device of claim 12, further comprising:
a housing including a first surface oriented in a first direction, a second surface oriented in a second direction opposite to the first direction, and a side wall formed to at least partially surround a space between the first surface and the second surface; and
an opening formed in the second surface of the housing,
wherein the cover member is mounted to close the opening, and the sensor layer is mounted in the housing.

14. The electronic device of claim 7 or 12, wherein the guide walls are formed on at least one of the molding layer, the adhesive layer, and the cover member.

15. The electronic device of claim 12, wherein the adhesive layer includes:
a base film having a shape corresponding to the surface of the molding layer;
a plurality of through holes formed in the base film; and
an adhesive applied to at least one surface of the base film, and
the through boles or a portion of the base film between the through holes form the guide walls.

16. The electronic device of claim 7, wherein the guide walls are formed on at least one of the molding layer, the adhesive layer, and the cover member.

17. The electronic device of claim 7, wherein the adhesive layer includes:
a base film having a shape corresponding to the surface of the molding layer;
a plurality of through holes formed in the base film; and
an adhesive applied to at least one surface of the base film, and
the through boles or a portion of the base film between the through holes form the guide walls.
